(19) United States
(12) Patent Application Publication
(10) Pub. No.: US 2010/0210454 A1
(43) Pub. Date: Aug. 19, 2010

(54) NANOCOMPOSITE CATALYST MATERIALS COMPRISING CONDUCTIVE SUPPORT (CARBON), TRANSITION METAL COMPOUND, AND METAL NANOPARTICLES

(76) Inventors: Albert Epshteyn, College Park, MD (US); Andrew P. Purdy, Alexandria, VA (US); Yannick Garsany, Baltimore, MD (US); Karen Swider-Lyons, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/705,255

(22) Filed: Feb. 12, 2010

Related U.S. Application Data
(60) Provisional application No. 61/151,576, filed on Feb. 11, 2009.

(51) Int. Cl. B01J 23/42; B01J 21/18

(52) U.S. Cl. 502/185; 977/773; 977/775

(57) ABSTRACT

The present invention is generally directed to a nanocomposite catalyst material for electrochemical devices such as fuel cells, comprising metal nanoparticles impregnated on a conductive support that is coated with a transition metal compound. The metal nanoparticles may comprise platinum; the metal phosphate may comprise tantalum oxyphosphate, niobium oxyphosphate, tantalum oxide, niobium oxide, or any combination thereof; and the conductive support may comprise carbon. In addition, the present invention provides for a method of making the catalyst material.

### PRIORITY CLAIM

The present application claims priority from U.S. Provisional Application No. 61/151,576 filed on Feb. 11, 2009 by Albert Epshteyn et al., entitled “METHOD OF SYNTHESIS OF NANOCOMPOSITE MATERIALS COMPRISED OF CARBON, METAL PHOSPHATE, AND METAL NANOPARTICLES,” the entire contents of which are incorporated herein by reference.

### BACKGROUND OF THE INVENTION

1. Field of the Invention

The present invention relates generally to catalysts and, more specifically, to nanocomposite catalyst materials for electrochemical devices.

2. Description of the Prior Art

A fuel cell produces electrons via the electrocatalytic oxidation of a fuel (e.g., H₂, methanol, etc.) and reduction of an oxidizer (e.g., O₂) as written in Equations 1 and 2, respectively. The H₂ (fuel) is oxidized at the anode to protons that flow through an electrolyte and recombine at the cathode via the reduction of oxygen to water. The electrons flow through an external circuit and bear the potential of the voltage difference between the electrocatalytic reactions at the cathode and anode, minus ohmic losses. The ohmic losses are decreased by using platinum electrocatalysts that lower the polarization losses of the fuel-oxidation and oxygen-reduction reactions, resulting in an increase in efficiency.

H₂→2H⁺+2e⁻ [1]

O₂+4H⁺+4e⁻→2H₂O [2]

The best catalysts for hydrogen oxidation and oxygen reduction are presently nanoscale platinum and platinum based alloys supported on carbon. Significant effort is taking place worldwide to increase the activity of the catalysts so that less catalyst can be used, and the cost of the fuel cell can be lowered.

Another challenge in the development of new fuel cell catalysts is their long-term operation in an acidic, electrochemical environment. At fuel cell cathodes, the catalyst faces highly oxidizing conditions that corrode most materials. During operation of fuel cells, the Pt dissolves resulting in particle migration and growth over time and therefore loses surface area and activity. Pt in contact with carbon also catalyzes the breakdown of the carbon support via oxidation to CO₂.

Other researchers have noted that the oxygen reduction reaction (ORR) on Pt is promoted in the presence of phosphotungstic acid, but, in that experiment, the Pt and phosphates were not prepared together as a single catalyst and the phosphotungstic acid was dispersed in solution (Giordana et al. Electrochim. Acta, 38, 1733 (1993), the entire contents are incorporated herein by reference). Phosphate-based catalysts can be used for direct conversion of methane into oxygenates and oxidative dehydrogenation. Typically, anhydrous materials are used for these applications. (Otsuka et al., “Direct conversion of methane into oxygenates,” Applied Catal. A: General, 222, 145-161 (2001); Ohdan et al., “Oxidation by iron phosphate catalyst,” J. Molec. Catal. A: Chemical, 159, 19-24 (2000), the entire contents of each are incorporated herein by reference). Hydrous iron phosphates have been investigated as corrosion barriers, paint additives and friction coatings. A polymorph of a hydrous FePO₄ has been tested as a positive electrode in Li-ion batteries (Padhi et al., “Phospho-olivines as positive-electrode materials for rechargeable lithium batteries,” J. Electrochem. Soc., 144 (4): 1, the entire contents of which is incorporated herein by reference).

### BRIEF SUMMARY OF THE INVENTION

The aforementioned problems are overcome in the present invention which provides a nanocomposite catalyst material for electrochemical devices such as fuel cells, comprising metal nanoparticles impregnated on a conductive support that is coated with a transition metal compound. The metal nanoparticles may comprise platinum; the transition metal compound may comprise tantalum oxyphosphate, niobium oxyphosphate, tantalum oxide, niobium oxide, or any combination thereof; and the conductive support may comprise carbon. In addition, the present invention provides for a method of making the catalyst material.

The purpose of the present invention is to make a more active catalyst. One potential use for this invention is for the oxygen reduction reaction in electrochemical devices such as proton exchange membrane (PEM) fuel cells. New compositions are developed for catalysts comprised of metal (e.g., Pt) nanoparticles dispersed on a transition metal compound such as a metal phosphate (e.g., tantalum and niobium oxyphosphates) and a conductive high-surface-area support (Vulcan carbon). The new compositions of the present invention include nanoscale Pt impregnated on a nanoscale layer of metal oxy-phosphate, all deposited on high surface area carbon to make a nanocomposite. These new nanocomposite compositions are enabled by new synthetic approaches of the present invention.

One advantage of the Pt-phosphate catalysts of the present invention is that they have higher electrocatalytic behavior for the oxygen reduction reaction as compared to standard carbon-supported Pt catalysts under conditions of a proton exchange membrane fuel cell. This will enable a fuel cell with lower Pt loadings or a more powerful fuel cell with the same Pt loading, which would make fuel cells less costly/more effective and therefore more viable for commercialization.

The improved behavior of these Pt-phosphate-carbon catalysts is attributed to a catalyst-support interaction which improves how oxygen is catalyzed on the Pt. Phosphates are known for their oxygen affinity, so the phosphate structure may increase the amount of oxygen “dragged” to the electrode for the ORR. Another advantage is that the Pt is fully distributed throughout the material, which should prevent migration and ripening of the Pt nanoparticles. The phosphate also stands between the Pt and the carbon, and may help mitigate carbon corrosion. The support might also mitigate migration of the Pt nanoparticles.

The catalysts of the present invention may also be used for oxygen evolution (the conversion of water to oxygen), hydrogen oxidation and hydrogen evolution. They might be used for oxygen reduction in other electrochemical devices, such as metal-air batteries. These catalysts might also be useful in heterogeneous catalysis reactions that normally utilize platinum, such as dehydrogenation reactions.

These and other features and advantages of the invention, as well as the invention itself, will become better understood by reference to the following detailed description, appended claims, and accompanying drawings.

### BRIEF DESCRIPTION OF THE DRAWINGS

FIG. 1 shows schematics of different catalyst formulations: (a) Pt/TaOPO₄ physically mixed with carbon and (b) nanocomposite of Pt/TaOPO₄ impregnated on carbon.

FIG. 2 shows an SEM micrograph of TaOPO₄ nanoparticles from Method 1 (refinement of adapted reverse-micelle approach) dilute reaction.

FIG. 3 shows an SEM micrograph of TaOPO₄ nanoparticles produced via Method 2 (development of water soluble Ta precursor for complete reverse micelle method).

FIG. 4 shows CVs of Pt/VC(NRL standard) and Pt/[TaOPO₄/VC]_SD-1 HT2 in deareated 0.1 M HClO₄ at 30° C. recorded at ν=200 mV s⁻¹.

FIG. 5(a) shows ORR polarization curves recorded for Pt/VC (NRL standard), Pt/[TaOPO₄/VC]_SD-1 HT, and Pt/[TaOPO₄/VC]_SD-1 HT2 in 0.1 M HClO₄ solution saturated with O₂; 1600 rpm, 20 mV s⁻¹. Anodic scans shown. FIG. 5(b) shows electrode potential vs. kinetic current density for the ORR on the different tantalum oxy-phosphate supported catalysts as well as Pt/VC (NRL standard). Kinetic currents were extracted from anodic polarization curves presented in FIG. 5(a).

FIG. 6 shows a comparison of iR corrected MEA polarization curves for Pt/VC (up-triangle), Pt/TaOPO₄+VC (square), Pt/[TaOPO₄/VC]_RM-1 (diamond), Pt/[TaOPO₄/VC]_RM-2 (hexagon), and Pt/[TaOPO₄/VC]_SD-1 (down-triangle). 10 cm² single cell, anode/cathode: H₂|O₂, 80° C., 100|96% RH, Stoich 2/10.

FIG. 7 is a comparison of mass (A) and specific activities (B) of RDEs and MEAs with Pt/VC (NRL standard), Pt/TaOPO₄+VC, Pt/[TaOPO₄/VC]_RM-1, Pt/[TaOPO₄/VC]_RM-2, and Pt/[TaOPO₄/VC]_SD-1 calculated at E=0.90 V (for RDEs measurements) and E=0.85 V (for MEA measurements).

### DETAILED DESCRIPTION OF THE INVENTION

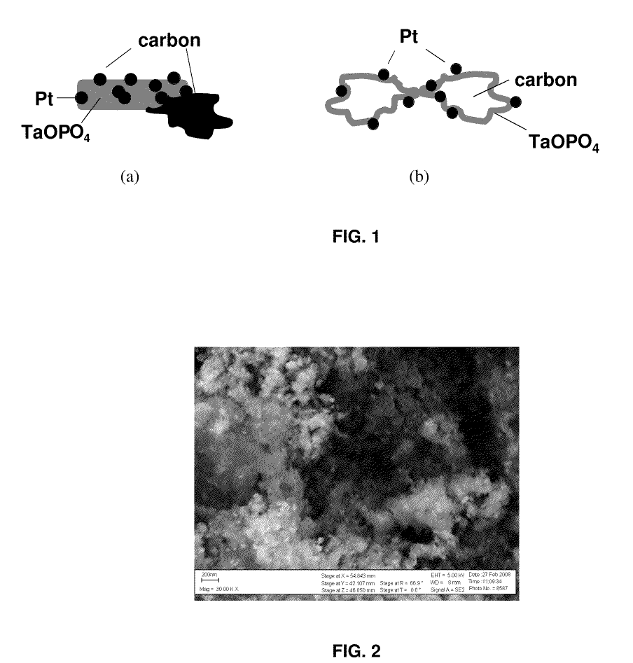

One embodiment of the present invention provides a method to increase the contact between Pt nanoparticles catalysts with an insulating oxy-phosphate phases and the carbon support through the use of high surface area nanoparticles. Earlier catalysts were made by a physical mixture of Pt-impregnated metal oxy-phosphate with Vulcan carbon (VC), as shown in FIG. 1(a). The physical mixture of the catalyst with the conductive support was used to eliminate any effect of the carbon support on the catalytic metal-support interactions between the Pt and metal phosphate, and thus prove the catalytic effect. (U.S. Pat. No. 7,255,955 to Lyons et al. issued Aug. 14, 2007; Bouwman et al., “Platinum iron phosphates for oxygen reduction in PEMFCs,” J. Electrochem. Soc., 151, A1989-A1998 (2004); Lyons et al., “Oxygen reduction on oxide- and phosphate supported noble metal catalysts,” Catalysts for Oxygen Electro reduction—Recent Developments and New Directions, 169-193 ESBN: 978-81-7895-313-7, Ting He, ed. (2009), the entire contents of each are incorporated herein by reference.) Similar approaches have also been demonstrated for the synthesis of Pt nanoparticles on tantalum oxide (Ta₂O₅) and Vulcan carbon. (Baturina et al., “Oxygen Reduction Reaction on Platinum/Tantalum Oxide Electrocatalysts,” J. Electrochem. Soc., 155, B1314-B1321 (2008), the entire contents of which are incorporated herein by reference.)

Embodiments of the present invention include new compositions and methods derived from synthesizing the catalysts by directly impregnating the platinum nanoparticles onto nanoscale metal oxy-phosphate that is supported on the Vulcan carbon support. While earlier work demonstrated compositions in the range of 10% Pt with 40% metal phosphate and 50% carbon, with no more than 30% Pt by weight; the present invention discloses nanocomposites with a broader range of compositions of trace to 70% Pt, trace to >99% metal oxy-phosphate, with the remainder (0 to 70%) being a conductive support (e.g., carbon). A schematic is shown in FIG. 1(b). Additionally, in earlier work, catalysts were only heated to 150° C.; in the present invention we disclose an additional heating step, with much higher treatment temperatures of up to 800° C. in an inert/reducing environment.

With the new nanocomposite formulations, the Pt is separated from the carbon support by the transition metal compound. Future testing may show that the Pt-activated corrosion of carbon may be mitigated. The new synthetic methods of preparing the materials include reverse micelle synthesis and solution deposition methodologies. All the new composites were tested for catalytic activity via testing in small membrane electrode assemblies. Platinum supported simply on the oxides of tantalum (Ta₂O₅) and niobium (Nb₂O₅) were also investigated.

Another embodiment of the present invention is a synthetic approach to making the Pt/[TaOPO₄/VC] composite materials via a “one-pot procedure” which will be simple to scale up, and to use only small amounts of the expensive components (such as tantalum). A solution deposition method is used to make materials this way.

The new synthetic approaches of the present invention significantly improve the architecture and physical characteristics of the catalyst, making it more robust and having much greater activity. The mass activity of the new platinum on tantalum oxy-phosphates and Vulcan carbon [Pt/[TaOPO₄/VC] is four times higher than our standard Pt/VC, with still a 1.6 times increase in SA as measured in MEAs.

In addition to the Pt—FePOx and Pt—NbPOx compounds described in this application, other viable catalysts compositions include phosphates of the following: Ti, Y, Sb, W, Mo and Ta, and mixed-metal phosphates including Fe and Nb and doped with other transition-metal elements. Moreover, the catalyst may be further improved and optimized for activity and durability by using various variables including, but not limited to, any one or combination of the following:
Varying the Pt particle size, heating conditions, and amount of ionomer used in the preparation of inks;
Replacing Pt nanoparticles with Pt-alloy nanoparticles such as Pt₃Co or Pt₃Ni, or others;
Replacing the carbon support to other current collecting materials such as metal carbides or phosphides;
Substituting Ta partially or fully with other transition metals such as V, Nb, Ta Ti, Zr, and Hf, and possibly Y, La, Ce, Cr, Mo, W, Mn, Fe, Sn, and Co, etc. to change the coating's electronic, morphological, and curing/annealing properties;
Varying the Pt:M:C ratios, to be composed of a variety of metal phosphates that contain anywhere from trace to 50 wt % of any of the aforementioned metals (V, Nb, Ta Ti, Zr, and Hf, and possibly Y, La, Ce, Cr, Mo, W, Mn, Fe, and Co, etc.) as metal phosphates, and included as a support coating that holds the catalyst particles in place, with various combinations and ratios of the metals;
Possibly a partial or complete substitution of the phosphates with pure or mixed borates, aluminates, silicates, selenates, tellurates, germanates, stannates in various combinations and ratios;
Delivering/dispersing the Pt, or other catalysts, on the surface using different methodologies—such as a chemical precursor, but decomposes upon heating to make catalyst particles or film dispersed evenly over the surface of the material; and
Dispersing the catalyst particles (such as Ni, Pt, Pd, Au, Ru, Re, Ir, Rh, Ag, or any other metal particles catalyst) in a highly uniform manner on the early transition metal compound coating, and then annealing the material under inert or inert/hydrogen atmosphere anywhere from 100 to 1300° C. (wherever you achieve the highest catalytic activity for your particular application). This should be possible to do at any catalyst loading—from trace amounts of catalyst (such as <1% Pt) all the way to high loadings of >80% by weight.

### Synthetic Approaches to Assemble Nanocomposite Materials Comprised of Conductive Support (Carbon), Transition Metal Compound, and Metal Nanoparticles

### Method 1

### Refinement of Adapted Reverse-Micelle Approach

To increase the surface area of a transition metal compound in contact with both the Pt and Vulcan carbon, a reverse micelle method was adapted from the literature synthesis of zirconium phosphate (ZrPO₄) nanoparticles to make TaOPO₄ nanoparticles (Bellezza et al., Colloid. Polym. Sci., 285, 19 (2006), the entire contents of which are incorporated herein by reference). This synthesis used Igepal surfactant with a water/cyclohexane solvent system. The main difficulty with the adaptation of this synthesis was the instability of the Ta alkoxide precursors (Ta(OEt)₅) in water. The Ta alkoxides spontaneously reacted and precipitated from solution, presumably due to the formation of insoluble oxo-Ta polymeric/oligomeric species, making this traditional reverse micelle approach not possible. A new synthesis was developed where only the H₃PO₄ was dissolved in the aqueous reverse micelle phase, while the Ta(OEt)₅ was introduced directly into the organic (cyclohexane) phase.

The Pt/[TaOPO₄/VC] catalyst was prepared in two steps. The first step, which involved the synthesis of tantalum oxy-phosphate (TaOPO₄) nanoparticles directly on Vulcan carbon (VC) by reverse micelle method, was adapted from the literature synthesis of zirconium phosphate (ZrPO₄) nanoparticles, but was modified to compensate for the extreme reactivity of Ta(EtO)₅ with water by introducing the Ta(EtO)₅ drop-wise.

### Synthesis of TaOPO₄/VC by Adapted Reverse Micelle Process

A stock solution of 0.15 M Igepal 520 in cyclohexane was prepared. 30 mL of this surfactant solution was mixed with the appropriate amount of 1.2 M H₃PO₄ to obtain a target water-to-surfactant molar ratio R_{W} and oil-to-water ratio Rₒ. The resulting microemulsion was sonicated for 40 min to 2 h. Then, in a N₂ glove box, a stock solution of Ta(OEt)₅ was diluted to 0.246 M with 10 mL of cyclohexane. Using an addition funnel, 3 mL of 0.246 M Ta(OEt)5/cyclohexane solution was added to the sonicated microemulsion under constant stirring. After addition of the Ta(OEt)₅/cyclohexane aliquot, the solution was kept under constant stiffing for 1 h at room temperature. Meanwhile, 150 mg of VC was dispersed into 30 mL of cyclohexane, and sonicated for 60 min.

Then the 30 mL VC/cyclohexane mixture was added to the microemulsion to form hydrated tantalum oxyphosphate particles in micelles. This suspension was kept under constant stirring overnight. The resulting TaOPO₄/VC sample was recovered by centrifugation and a black powder obtained. This black powder was washed with cyclohexane (3×25 mL), then with EtOH (3×25 mL) with centrifugation done between each washing step, and finally dried at 80° C. under vacuum for 2 h. A fraction of the resulting black powder was heat treated at 150° C. for 12 h in air in a furnace oven.

### Synthesis of PT Nanoparticles

The following procedures were used in all of the synthesis methods to make Pt nanoparticles from Pt colloids. Pt colloids were prepared according to Wang et al., Chem. Mater., 12, 1622 (2000), the entire contents of which are incorporated herein by reference. Under an inert (N₂) atmosphere, an ethylene glycol solution of NaOH (50 mL, 0.5 M) was added to an ethylene glycol solution of H₂PtCl₆.6H₂O (50 mL, 1.93 mmol). The resulting orange-yellow solution was heated to 160° C. for 3 h under nitrogen flow. A transparent brown Pt colloidal solution was obtained and stored under N₂. Upon cooling to room temperature, the solution was filtered to remove small amounts of macroscopic Pt residues and the concentration of the colloid was determined by subtracting the residue mass from the theoretical Pt content.

The platinum nanoparticles were precipitated from the platinum colloid by acidification via the addition of an aqueous solution of 0.1 M HClO₄. (e.g., ˜7.70 mL of Pt solution was added to ˜12 mL 0.1 M HClO₄ while stiffing.) Deposition occurred at pH<4, in agreement with prior observations. The resulting nanoparticles were separated by centrifugation and dispersed in absolute EtOH by sonication in an ultrasonic bath for 5 min immediately before addition to the metal oxy-phosphate supports.

Deposition of Pt Nanoparticles onto the TaOPO₄/VC:

100 mg of heat-treated TaOPO₄/VC powder was dispersed in 15 mL absolute ethanol using a high shear mixer for 2 min. After sonication, the TaOPO₄/VC solution was transferred to a 100 mL round bottom flask, and an additional 25 mL of absolute ethanol was added to this solution under stirring. A dispersion of Pt nanoparticles in ethanol was added to the 40 mL TaOPO₄/VC solution and kept under constant and vigorous stiffing for a minimum of 45 h. The resulting Pt/[TaOPO₄/VC] deposit was isolated by centrifugation and washed by repeated (6 times) redespersion-centrifugation procedure with absolute ethanol. The Pt/TaOPO₄ was dried in a vacuum oven at room temperature for 12 h and heated in air at 200° C. for 4 h in a furnace oven before use in inks formulation.

FIG. 2 shows an SEM micrograph of TaOPO₄ nanoparticles from Method 1 (refinement of adapted reverse-micelle approach) dilute reaction.

### Method 2

### Development of Water Soluble Ta Precursor for Complete Reverse Micelle Method

The development of a stable water-soluble tantalum species was complicated by the instability of Ta(OEt)₅ in water. The approach of stabilizing the tantalum in the form of a tantalate anion equivalent was chosen as one having the most probability for success. This approach for stabilization of Ta(EtO)₅ in water was published, although the stabilized complex was not isolated, characterized, or used synthetically in the same manner (Shenghai et al., Rare Metals Materials and Engineering, 36, 282 (2007), the entire contents of which are incorporated herein by reference.).

### Method for Synthesis of Water Soluble Ta-Salt: Tetramethylammonium Tantalate (Me₄NTaO₄)

Tetramethylammonium was chosen as the counter-ion for the preparation of a tantalum-salt due to its high solubility in aqueous media. Tetramethylammonium hydroxide was dissolved in EtOH, and Ta(OEt)₅ was added to it slowly drop-wise under inert atmosphere while stirring vigorously. The preparation was optimized to where it produced no precipitate. Since the product was to be used in aqueous reactions in the reverse micelle preparations, the EtOH had to be removed (in vacuo), or else it would interfere with the polarity of the microemulsion solvent system and possibly disrupt the micelles (EtOH is used to break up microemulsions/reverse micelles). (Prep: Ta(OEt)₅ (1.0 mL, 3.8 mmol) was dissolved in a flask with 15 mL EtOH. While stirring vigorously under a N_{2(g)} atmosphere, 1.58 g (4.3 mmol) of a ˜25% Me₄NOH solution in water was added. All solvents were removed under vacuum leaving a white solid.)

After the dry material was prepared, it was highly water soluble and indefinitely stable in aqueous solution; however, in dry form the material was not stable, and over time ceased to fully dissolve in water. It was presumed that this instability in dry form was due to the decomposition of ammonium hydroxides leading to elimination of water and polymerization of the tantalate ions producing insoluble tantalum-oxide/hydroxides. As already mentioned, this problem was easily corrected by keeping the species dissolved in water and used as a stock solution.

Synthesis of Pt/[TaOPO₁/VC] by Reverse Micelle with Water Stable Ta-Salt:

A microemulsion designated μA was obtained by adding an aliquot of aqueous solution of 0.16 M H₃PO₄ (325 μL) to 20 mL of 0.15 M cyclohexane/Igepal solution, to obtain a surfactant/water molar ratio (R_{W}) equal to 6.

A microemulsion designated μB was obtained by adding an aliquot of aqueous solution of 0.15 M Me₄NTaO₄ (325 μL) to 20 mL of 0.15 M cyclohexane/Igepal solution, to obtain a surfactant/water molar ratio (R_{W}) equal to 6.

μA & μB were sonicated for 55 min. Meanwhile, 150 mg of VC was dispersed into 10 mL of cyclohexane, and sonicated for 60 min. Then, μA & μB were added simultaneously to 150 mL cyclohexane solution and stirred for 2 h at room temperature. The μA & μB+cyclohexane mixture was then added to VC/cyclohexane mixture to form the tantalum oxy-phosphate nanoparticles in micelles. This suspension was kept under constant stirring overnight. The resulting TaOPO₄/VC sample was recovered by centrifugation. This black powder was washed with cyclohexane (3×25 mL), then with EtOH (3×25 mL) with centrifugation done between each washing step, and finally dried at 80° C. under vacuum for 2 h. A fraction of the resulting black powder was heat treated at 150° C. for 12 h in air in a furnace oven.

### Impregnation of Pt Nanoparticles on [TaOPO₄/VC]:

111 mg of the heat treated TaOPO₄/VC catalyst was dispersed in 17 mL EtOH using a high-shear mixer for 1 min. Then the TaOPO₄/VC solution was sonicated for 155 min. After sonication, the TaOPO₄/VC solution was transferred to a 100 mL round bottom flask, and an additional 50 mL of EtOH was added to this solution under stirring. Then, a dispersion of Pt nanoparticles in EtOH (as described above under Method 1) was added to 65 mL TaOPO₄/VC solution and kept under constant and vigorous stiffing for a minimum of 45 h. The resulting Pt/[TaOPO₄/VC] deposit was isolated by centrifugation and cleaned by repeated (6 times) redespersion-centrifugation procedure with EtOH. The Pt/[TaOPO₄/VC] was dried in vacuum at room temperature for 12 h and heated in air at 200° C. for 4 h in a furnace oven before using the ink formulation.

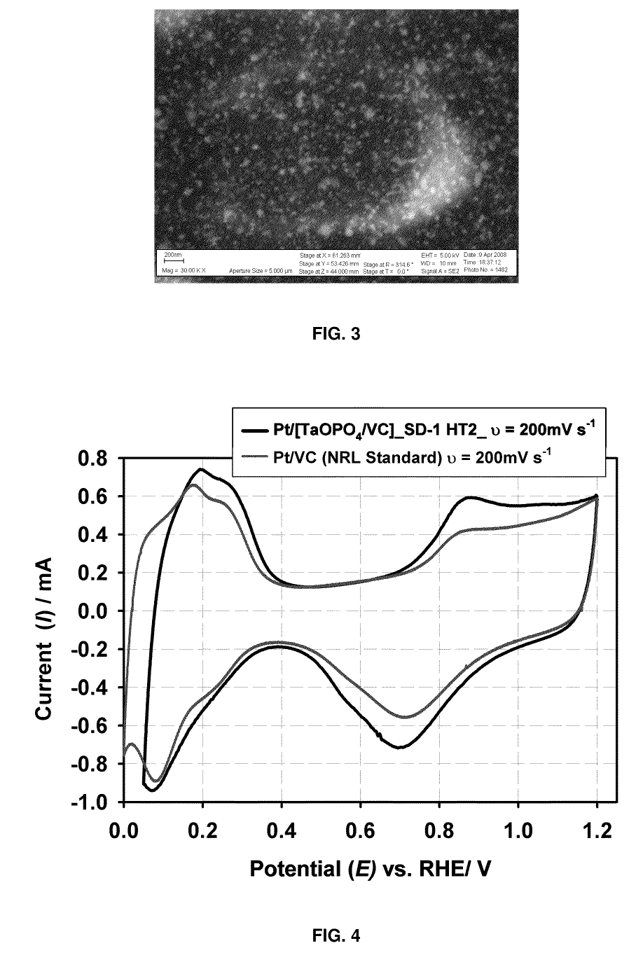

FIG. 3 shows an SEM micrograph of TaOPO₄ nanoparticles produced via Method 2 (development of water soluble Ta precursor for complete reverse micelle method).

### Method 3

### Solution Deposition of Metal Salts onto VC Substrate

A procedure was developed to deposit predetermined amounts of metal salts onto the VC substrate by a one-pot method using solution deposition methods. Ultrasound was used to disperse the constituents within the substrate, for which a simple bench-top ultrasonic cleaning bath was used. Aqueous H₃PO₄ was dried to make polyphosphoric acid which was subsequently dissolved into EtOH along with VC, and these components were sonicated before the addition of Ta(OEt)₅. Pt nanoparticles were crashed out, washed, and subsequently re-suspended in EtOH, and then added to the reaction (as described above in Method 1). All the components were sonicated together over several days. The same procedure was used for the preparation of the NbOPO₄ treated material, and a similar procedure was used to make the Ta₂O₅ and Nb₂O₅ treated materials, but instead of polyphosphoric acid, water was added to the reactions following the dispersion of the metal alkoxide on the VC substrate to lead to the oxides.

### Synthesis of Solution Deposition Assembled Catalysts

80% H₃PO₄ was dried at 150° C. in a vacuum oven overnight (producing polyphosphoric acid), and then dissolved in EtOH. The VC was suspended in EtOH and mixed with the polyphosphoric acid EtOH solution and left sonicating for 2 h. Ta(EtO)₅ in EtOH was then added to the reaction, and it was sonicated overnight. The appropriate amount of Pt colloid was precipitated, re-suspended in EtOH and injected into the same flask. The reaction was sonicated for 2 days and then the material was spun at 9300 g in the centrifuge, dried under vacuum and then heat treated in inert atmosphere (N₂) to various temperatures (100 to 800° C.) that depend on Pt loading of the material for a variable period, depending on the final particle morphology that we wanted to achieve, in a furnace oven before using in the ink formulation for rotating disc electrode (RDE) or membrane electrode assembly (MEA) testing.

### Catalyst Performance Evaluation

Using the RDE methodology, the performance of the catalysts was compared to a standard Pt/VC catalyst prepared with the same Pt deposited on the TaOPO₄/VC in the composite materials made by both reverse micelle (RM) and solution deposition (SD) methods. Detailed experimental procedures are in Garsany et al., J. Electrochem. Soc., February 2010, the entire contents of which are incorporated herein by reference.

The results of the elemental analysis on the Pt/[TaOPO₄/VC] catalysts are presented in Table I. Elemental analysis performed by Columbia Analytical Services, Inc. Particle sizes are determined via X-ray diffraction (XRD).

TABLE I
Elemental analysis of the Pt/[TaOPO₄/VC] catalysts
by weight % and particle sizes by XRD.

| | | | | | | Pt particle |
|---|---|---|---|---|---|---|
| | Synthetic | | | M | | sizes by XRD |
| Catalysts description | method | VC % | Pt % | (Ta or Nb) % | P % | (nm) |
| Pt/VC (NRL Std) | Baturina | 76.9 | 23.1 | NA | NA | 1.2-1.4 |
| | et al. | | | | | |
| Pt/TaOPO₄ + VC | Garsany | NA | 21.5 | 40.9 | 7.5 | 1.5-1.7 |
| | et al. | | | | | |
| Pt/[TaOPO₄/VC]_RM-1 | 2 | 68.7 | 16.9 | 4.90 | 0.80 | 1.2-1.4 |
| Pt/[TaOPO₄/VC]_RM-2 | 2 | 76.9 | 23.1 | 4.05 | 0.48 | 1.2-1.4 |
| Pt/[TaOPO₄/VC]_SD-1 | 3 | 71.3 | 16.1 | 1.02 | 0.36 | 1.2-1.4 |
| Pt/[TaOPO₄/VC]_SD-1 | 3 | 72.2 | 16.5 | 1.10 | 0.60 | 1.7-1.8 |
| HT^{a} | | | | | | |
| Pt/[TaOPO₄/VC]_SD-1 | 3 | 73.9 | 14.2 | 3.48 | 0.88 | 2.4 |
| HT2^{b} | | | | | | |
| Pt/[NbOPO₄/VC]_SD-3 | 3 | 74.15 | 17.98 | 0.56 | 1.25 | 1.2-1.4 |

RM = reverse micelle; SD = solution deposition. The synthetic methods are described above.
Pt/[TaOPO₄/VC]_SD-1 HT^{a}: Sample heat treated at 150° C. in N₂/H₂ for 4 h.
Pt/[TaOPO₄/VC]_SD-1 HT2^{b}: Sample heat treated at 650° C. in N₂/H₂ for 2 h.

### Comparison of Catalyst Electrochemical Surface Area

Cyclic voltammograms (CVs) are presented in FIG. 4 for the Pt/VC (NRL standard) and Pt/[TaOPO₄/VC]_SD-1 HT2 catalyst. The CVs were recorded at a scan rate of 200 mV s⁻¹ in a N₂-saturated 0.1 M HClO₄ electrolyte at 30° C. The CV response of the tantalum oxy-phosphate catalyst exhibit the three characteristic potential regions observed for polycrystalline Pt: the hydrogen adsorption/desorption potential region at 0.05≦E≦0.40 V, followed by the double layer potential region at 0.40≦E≦0.70 V and the Pt—OH adsorption/reduction potential region at 0.70≦E≦1.25 V. The Pt—OH region is observed in the same potential region as for the Pt/VC, with no significant shift of the onset potential of the —OH adsorption seen for Pt on the tantalum oxy-phosphate.

The RDEs Pt loading and electrochemical surface area (ECSA), A_{Pt,cat}(m²_{Pt} g_{Pt}⁻¹) of the tested catalysts are summarized in Table II. The ECSA of the Pt in each sample was calculated by integrating the columbic charge Q in (C) under both the hydrogen adsorption and desorption region from ca. 0.10 V-0.40 V (using cyclic voltammograms recorded at 30° C., and at a ν=200 mV s⁻¹), and then corrected for H₂ crossover and double layer capacitance of the carbon support and Pt/TaOPO₄ using Equation 3.

A_{Pt,cat}={Q/(210 μC cm⁻²_{Pt}(L_{ca}A_{g})}×10⁵ (3)

where L_{ca} is the cathode loading (mg_{Pt} cm⁻²) and A_{g} is the geometric surface area of the MEA (i.e. 0.196 cm²).

TABLE II
RDEs Pt loading (μg_{Pt} cm⁻²), and calculated
ECSA (A_{Pt, cat}) of the different catalysts.

| | Pt loading | ESCA |
|---|---|---|
| Catalysts | (μg cm⁻²) | m² g_{Pt}⁻¹ |
| Pt/VC (NRL Std) | 23 | 61 |
| Pt/TaOPO₄ + VC | 20 | 12 |
| Pt/[TaOPO₄/VC]_RM-1 | 17 | 63 |
| Pt/[TaOPO₄/VC]_RM-2 | 16 | 56 |
| Pt/[TaOPO₄/VC]_SD-1 | 18 | 83 |
| Pt/[TaOPO₄/VC]_SD-1 HT | 17 | 77 |
| Pt/[TaOPO₄/VC]_SD-1 HT2 | 15 | 89 |
| Pt/[NbOPO₄/VC]_SD-3 | 20 | 83 |

Pt/[TaOPO₄/VC]_SD-1 HT^{a}: Sample heat treated at 150° C. in N₂/H₂ for 4 h.
Pt/[TaOPO₄/VC]_SD-1 HT2^{b}: Sample heat treated at 650° C. in N₂/H₂ for 2 h.

Table II shows that the platinum ECSA is ˜5 to 7.5 times higher for Pt/TaOPO₄ catalysts synthesized by directly impregnated the Pt/TaOPO₄ composite on the VC support by reverse micelle synthesis vs. the ECSA of the Pt/TaOPO₄ composite mixed mechanically with the VC support (i.e. ˜75 m²g_{Pt}⁻¹ compared to only 12 m² g_{Pt}⁻¹). The ECSA of RM-1 and RM-2 catalysts are 63 and 56 m² g_{Pt}⁻¹, or statistically equivalent to the 61 m² g_{Pt}⁻¹ of the Pt/VC (NRL standard). The Pt/[TaOPO₄/VC]_SD-1 HT2 catalyst has the highest ECSA of all the catalysts of 89 m²_{Pt}g_{Pt}⁻¹. The lower ECSA of the Pt on the TaOPO₄ mixed mechanically with VC support vs. the nanoscale tantalum oxy-phosphate on the VC support is probably due to poor electronic contact between the Pt and the carbon, resulting in much of its Pt being electrochemically inactive. By directly impregnating the platinum nanoparticles on nanoscale tantalum oxy-phosphate on the VC support, the Pt particles only have a thin layer of tantalum oxy-phosphate separating them from the carbon, and thus they are not longer electrochemically isolated. Although tantalum oxyphosphate is highly insulating, it is well known that electrons tunnel through thin oxide films such as Al₂O₃.

### Oxygen Reduction Reaction (ORR) Kinetics

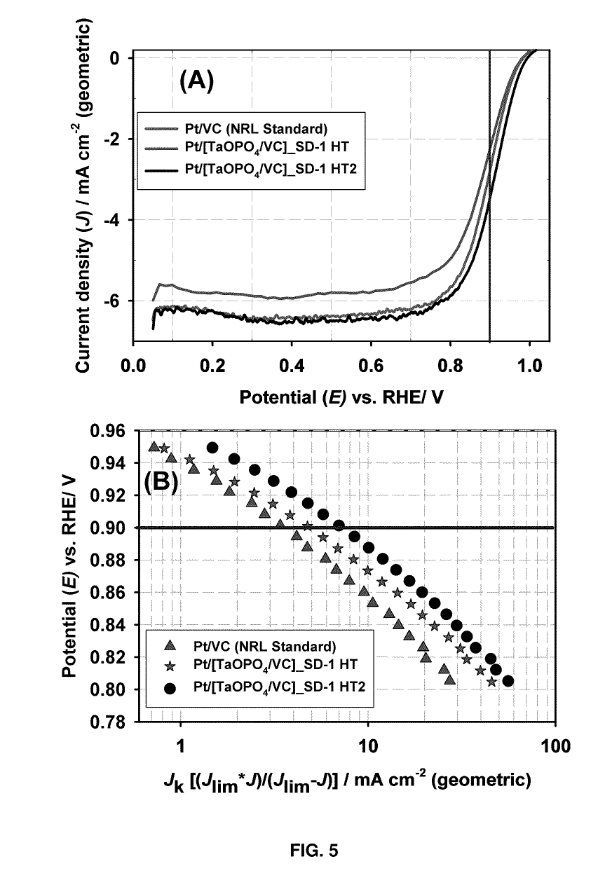

FIG. 5 shows examples of ORR polarization curves for thin film of Pt/VC (NRL standard) and two variations of the Pt/[TaOPO₄/VC] catalysts. The electrode potential is scanned from 1.03 V to 0.05 V back to 1.03 V, and only the anodic scans (i.e. 0.05 V to 1.03 V) are shown on FIG. 5(a).

A single, steep reduction wave with a well developed limiting current density plateau, Jₗᵢₘ, is observed in the potential region 0.20 V<E<0.70 V, followed by a mixed kinetic-diffusion control region between 0.75 V<E<1.00 V for all of the catalysts. The ORR polarization curves for the Pt/VC, SD-1 HT, and SD-1 HT2 Pt/[TaOPO₄/VC] catalysts measured at 1600 rpm, have their Jₗᵢₘ value of ˜−6 mA cm⁻² (geometric) in good agreement with the Jₗᵢₘ value observed for the Pt/TaOPO₄+VC catalyst and also well within the 10% margin of the theoretical diffusion limiting current (i.e. −5.7 mA cm⁻²) calculated using the Levich's equation, clearly indicating a negligible contribution from O₂ diffusion through the Nafion film and tantalum oxy-phosphate. All the catalysts supported on tantalum oxy-phosphate have nearly the same Pt loading (15-20 μg_{Pt} cm⁻², see Table II) as the Pt/C catalysts (˜24 μg_{Pt} cm⁻²); therefore their catalytic activity for the ORR can be compared visually by their arrangement on FIG. 5(a). The Pt/VC has the lowest activity for the ORR. Its half-wave potential ((E_{1/2})=0.86 V) is shifted towards more negative potentials compared to the tantalum oxy-phosphate catalysts (i.e. E_{1/2}=0.90 V for Pt/VC compared to E_{1/2}=0.92 V for SD-1 HT, and E_{1/2}=0.93 V for SD-1 HT2).

The E vs. log |jₖ| curves or Tafel plots for the ORR are shown in FIG. 5(b) for the Pt/VC (NRL standard) and the different tantalum oxy-phosphate catalysts. As observed for Pt supported catalysts, the Tafel slope for the ORR changes continuously in the potential range examined for all tested catalysts. The Tafel plot also show that trend in the catalytic activity for the ORR is SD-1 HT2>SD-1 HT>Pt/VC.

The actual electrocatalytic activity of catalysts is best compared by their mass- and area-specific activities using the mass transport-correction for thin-film RDEs. For this relative comparison, J is taken from the value of the curve at 0.90 V and the Jₗᵢₘ at 0.35 V. The mass-specific activities (A mg_{Pt}⁻¹) are estimated via calculation of Jₖ and normalization to the Pt-loading of the disk electrode. The area-specific activities (μA cm²_{Pt}) are estimated via the calculation of Jₖ and normalization to the platinum surface area, A_{Pt,cat}. Mass-specific and area-specific activities are listed in Table III and also compared to literature values.

TABLE III
Mass-specific (A mg_{Pt}⁻¹) and area-specific (μA cm⁻²_{Pt}) activities
for the different catalysts calculated at E = 0.90 V and 30° C.

| Catalysts | A mg_{Pt}⁻¹ | μA cm²_{Pt} |
|---|---|---|
| Pt/C (TKK) | 0.12 | 312 |
| Pt/HSC-E (TKK) ref (1) | 0.21 | 265 |
| Pt/VC (NRL Std) | 0.15 | 244 |
| Pt/TaOPO₄ + VC | 0.06 | 495 |
| Pt/[TaOPO₄/VC]_RM-1 | 0.19 | 311 |
| Pt/[TaOPO₄/VC]_RM-2 | 0.17 | 309 |
| Pt/[TaOPO₄/VC]_SD-1 | 0.27 | 324 |
| Pt/[TaOPO₄/VC]_SD-1 HT | 0.29 | 379 |
| Pt/[TaOPO₄/VC]_SD-1 HT2 | 0.48 | 539 |
| Pt/[NbOPO₄/VC]_SD-3 | 0.18 | 221 |

Pt/[TaOPO₄/VC]_SD-1 HT^{a}: Sample heat treated at 150° C. in N₂/H₂ for 4 h.
Pt/[TaOPO₄/VC]_SD-1 HT2^{b}: Sample heat treated at 650° C. in N₂/H₂ for 2 h.

Our Pt/VC standard has lower mass- and area-specific activities than 46% Pt/C (TKK) (0.21 A mg_{Pt}⁻¹ and 265 μA cm⁻²_{Pt}) (1), possibly due to the 1.2 nm size of our Pt clusters. The mass-specific activity at 0.90 V of the Pt/TaOPO₄+VC is ˜2.5 times lower than of the Pt/VC (0.06±0.02 A mg_{Pt}⁻¹ vs. 0.15±0.02 A mg_{Pt}⁻¹), and its area-specific activity is ˜2 times higher (495 μA cm⁻²_{Pt} vs. 244 μA cm⁻²_{Pt}). Low mass-specific activity is the result of poor electrochemical utilization of the Pt on the support, as discussed above. The SD-1 Pt/[TaOPO₄/VC] catalyst has ˜1.3 times higher mass activity than the Pt/VC (i.e. 0.26 A mg_{Pt}⁻¹ vs. 0.15 A mg_{Pt}⁻¹), and its area-specific activity is ˜1.3 times higher than that of the standard Pt/VC (324 μA cm⁻²_{Pt} vs. 244 μA cm⁻²_{Pt}). Further, the mass specific-activity of the SD-1 catalyst is 2.2 times higher than that of the commercial Pt/C catalyst (i.e. 0.26 A mg_{Pt}⁻¹ vs. 0.12 A mg_{Pt}⁻¹) and their area specific activities are very comparable. The RM-1 and RM-2 Pt/[TaOPO₄/VC] catalysts have ˜1.3 times higher mass activity than our Pt/VC standard (i.e. 0.19 A mg_{Pt}⁻¹ vs. 0.15 A mg_{Pt}⁻¹), but their area-specific activities are very comparable to that of the Pt/VC. The mass-specific activities of the tantalum oxy-phosphate catalysts synthesized directly on the VC (i.e. RM-1, RM-2 and SD-1) are ˜3.5 times higher than that Pt/TaOPO₄+VC (mechanical mixture), but their specific-area activities are ˜1.6 times lower.

Both heat treated Pt/[TaOPO₄/VC] (i.e. SD-1 HT and SD-1 HT2) catalysts have higher mass and area-specific activities than the commercial 46% Pt/C (TKK) and our standard Pt/VC. The mass and area-specific activities of the SD-1 HT2 catalyst is ˜4 times and ˜2 times higher than that of the commercial TKK catalyst respectively. The most active catalysts are based on Pt/TaOPO4, which show the highest mass and specific activities. The NbOPO₄ based catalyst is almost as active.

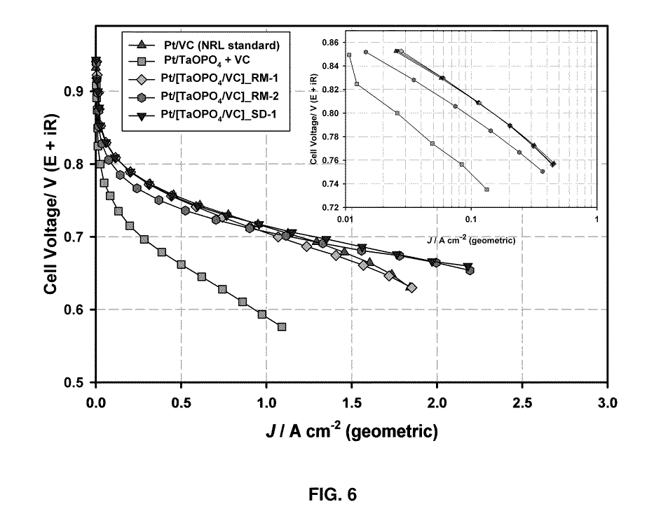

Some of the catalysts were also tested at the cathode catalysts in 10 cm² membrane electrode assemblies (MEAs). FIG. 6 shows the resistance-corrected (iR-free) polarization curves for MEAs with Pt/TaOPO₄+VC, Pt/[TaOPO₄/VC]_RM-1, Pt/[TaOPO₄/VC]_RM-2 and Pt/[TaOPO₄/VC]_SD-1 cathodes are compared to one with a Pt/VC cathode (NRL standard). The details of the MEA preparation are described in detail in Garsany et al., J. Electrochem. Soc., February 2010. The MEA containing the Pt/TaOPO₄+VC cathode was activated between 0.25 V and 0.70 V and all the other MEAs were activated between 0.50 V and 0.70 V. MEAs with Pt/[TaOPO₄/VC] cathode (i.e. RM-1, RM-2, and SD-1) have a much higher current density than the MEA with Pt/TaOPO₄+VC (mechanically mixed with the VC). The activity of Pt/[TaOPO₄/VC] nanocomposite catalysts exceeds the activity of the standard MEA with Pt/VC cathode, reflective of higher mass activity for these catalysts. Again this is evidence of improved contact of the Pt with the conducting carbon on these composite catalysts. The insert in FIG. 6 shows that the all the catalysts yield perfectly straight Tafel-lines with a slope ˜70 mV dec⁻¹ in a plot of iR-free voltage vs. the logarithm of the current density, in good agreement with Tafel slopes measured for Pt supported on carbon catalysts.

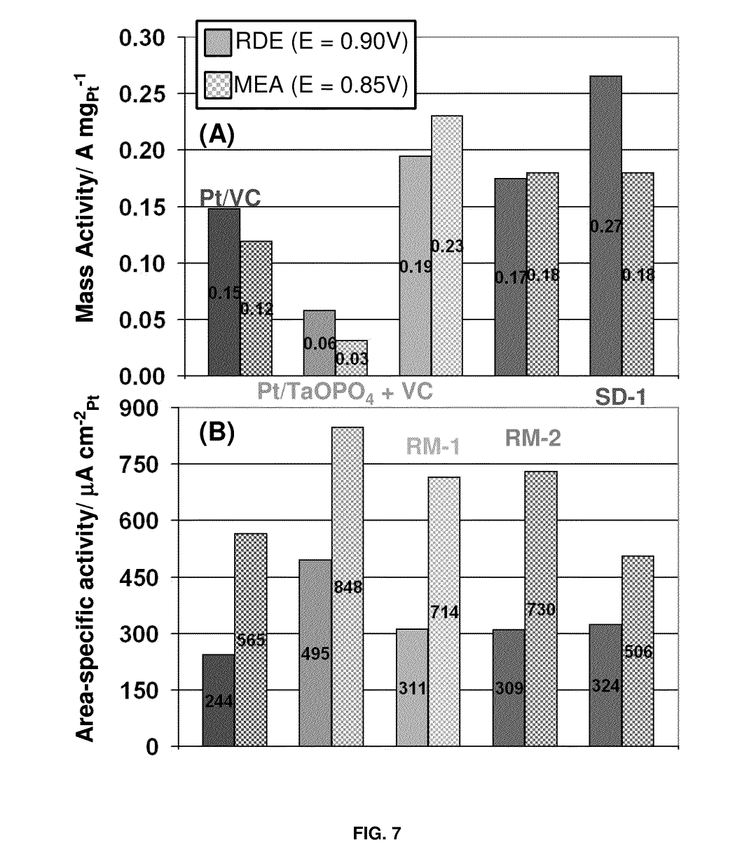

FIG. 7 compares the mass-specific activities and area-specific activities of selected catalysts from RDE measurements taken at E=0.90 V (reported in Table III) and MEA results at E=0.85 V (from FIG. 6). The results compare favorably, indicating that the RDE measurements are valid for the new catalysts of the present invention.

The above descriptions are those of the preferred embodiments of the invention. Various modifications and variations are possible in light of the above teachings without departing from the spirit and broader aspects of the invention. It is therefore to be understood that the claimed invention may be practiced otherwise than as specifically described. Any references to claim elements in the singular, for example, using the articles “a,” “an,” “the,” or “said,” is not to be construed as limiting the element to the singular.

What is claimed as new and desired to be protected by Letters Patent of the United States is:

1. A nanocomposite catalyst material, comprising metal nanoparticles impregnated on a conductive support that is coated with a transition metal compound.

2. The material of claim 1, wherein the metal nanoparticles comprise platinum.

3. The material of claim 1, wherein the metal nanoparticles comprise platinum-alloy nanoparticles.

4. The material of claim 1, wherein the transition metal compound comprises tantalum oxyphosphate, niobium oxyphosphate, or any combination thereof.

5. The material of claim 1, wherein the transition metal compound comprises tantalum oxide, niobium oxide, or any combination thereof.

6. The material of claim 1, wherein the transition metal compound comprises tantalum, vanadium, niobium, titanium, zirconium, hafnium, yttrium, lanthanum, cerium, chromium, molybdenum, tungsten, manganese, iron, tin, cobalt, or any combination thereof.

7. The material of claim 1, wherein the transition metal compound comprises a metal borate, aluminate, silicate, selenate, tellurate, germanate, stannate, or any combination thereof.

8. The material of claim 1, wherein the conductive support comprises carbon.

9. The material of claim 1, wherein the conductive support comprises metal carbides, metal phosphides, or any combination thereof.

10. The material of claim 1, wherein the material has a composition of trace to 70% metal nanoparticles, trace to 99% transition metal compound, and 0 to 70% conductive support.

11. A method of making a nanocomposite catalyst material, comprising impregnating metal nanoparticles onto a conductive support that is coated with a transition metal compound.

12. The method of claim 11, additionally comprising annealing the nanocomposite under inert or a mixed inert/hydrogen atmosphere in the range from 100 to 1300° C.

13. The method of claim 11, wherein the metal nanoparticles comprise platinum.

14. The method of claim 11, wherein the metal nanoparticles comprise platinum-alloy nanoparticles.

15. The method of claim 11, wherein the transition metal compound comprises tantalum oxyphosphate, niobium oxyphosphate, or any combination thereof.

16. The method of claim 11, wherein the transition metal compound comprises tantalum oxide, niobium oxide, or any combination thereof.

17. The method of claim 11, wherein the transition metal compound comprises tantalum, vanadium, niobium, titanium, zirconium, hafnium, yttrium, lanthanum, cerium, chromium, molybdenum, tungsten, manganese, iron, tin, cobalt, or any combination thereof.

18. The method of claim 11, wherein the transition metal compound comprises a metal borate, aluminate, silicate, selenate, tellurate, germanate, stannate, or any combination thereof.

19. The method of claim 11, wherein the conductive support comprises carbon.

20. The method of claim 11, wherein the conductive support comprises metal carbides, metal phosphides, or any combination thereof.

21. The method of claim 11, wherein the material has a composition of trace to 70% metal nanoparticles, trace to 99% transition metal compound, and 0 to 70% conductive support.
